(19) United States
(12) Patent Application Publication
(10) Pub. No.: US 2018/0143007 A1
(43) Pub. Date: May 24, 2018

(54) Method and Apparatus for Increasing the Frame Rate of a Time of Flight Measurement

(71) Applicant: Google LLC, Mountain View, CA (US)

(72) Inventor: Honglei Wu, Sunnyvale, CA (US)

(21) Appl. No.: 15/857,760

(22) Filed: Dec. 29, 2017

Related U.S. Application Data
(63) Continuation of application No. 14/675,233, filed on Mar. 31, 2015.

(51) Int. Cl. G01B 11/22; G01S 17/89; G01S 17/02; G01S 7/491; G01S 7/481; H04N 13/00; G01S 17/36

(52) U.S. Cl. CPC G01B 11/22; G01S 17/89; G01S 17/023; G01S 7/4914; G01S 7/4813; G01S 17/36; H04N 13/0029; H04N 13/0203; H04N 13/0051; H04N 13/0048

(57) ABSTRACT

An apparatus is described that includes a pixel array having time-of-flight pixels. The apparatus also includes clocking circuitry coupled to the time-of-flight pixels. The clocking circuitry comprises a multiplexer between a multi-phase clock generator and the pixel array to multiplex different phased clock signals to a same time-of-flight pixel. The apparatus also includes an image signal processor to perform distance calculations from streams of signals generated by the pixels at a first rate that is greater than a second rate at which any particular one of the pixels is able to generate signals sufficient to perform a single distance calculation.

### CROSS REFERENCE TO RELATED APPLICATION

This application is a continuation of U.S. application Ser. No. 14/675,233, filed Mar. 31, 2015, the contents of which are incorporated by reference herein.

### FIELD OF INVENTION

The field of invention pertains to image processing generally, and, more specifically, to a method and apparatus for increasing the frame rate of a time of flight measurement.

### BACKGROUND

Many existing computing systems include one or more traditional image capturing cameras as an integrated peripheral device. A current trend is to enhance computing system imaging capability by integrating depth capturing into its imaging components. Depth capturing may be used, for example, to perform various intelligent object recognition functions such as facial recognition (e.g., for secure system un-lock) or hand gesture recognition (e.g., for touchless user interface functions).

One depth information capturing approach, referred to as “time-of-flight” imaging, emits light from a system onto an object and measures, for each of multiple pixels of an image sensor, the time between the emission of the light and the reception of its reflected image upon the sensor. The image produced by the time of flight pixels corresponds to a three-dimensional profile of the object as characterized by a unique depth measurement (z) at each of the different (x,y) pixel locations.

As many computing systems with imaging capability are mobile in nature (e.g., laptop computers, tablet computers, smartphones, etc.), the integration of a light source (“illuminator”) into the system to achieve time-of-flight operation presents a number of design challenges such as cost challenges, packaging challenges and/or power consumption challenges.

### SUMMARY

An apparatus is described that includes a pixel array having time-of-flight pixels. The apparatus also includes clocking circuitry coupled to the time-of-flight pixels. The clocking circuitry comprises a multiplexer between a multi-phase clock generator and the pixel array to multiplex different phased clock signals to a same time-of-flight pixel. The apparatus also includes an image signal processor to perform distance calculations from streams of signals generated by the pixels at a first rate that is greater than a second rate at which any particular one of the pixels is able to generate signals sufficient to perform a single distance calculation.

An apparatus is describing having first means for generating multiple, differently phased clock signals for a time-of-flight distance measurement. The apparatus also includes second means for routing each of the differently phased clock signals to different time-of-flight pixels. The apparatus also includes performing time-of-flight measurements from charge signals from the pixels at a rate that is greater than a rate at which any of the time-of-flight pixels generate charge signals sufficient for a time-of-flight distance measurement.

### FIGURES

The following description and accompanying drawings are used to illustrate embodiments of the invention. In the drawings:

FIG. 1 (prior art) shows a traditional time-of-flight system;

FIGS. 2a and 2b pertain to a first improved time-of-flight system having increased frame rate;

FIGS. 3a through 3e pertain to second improved time-of-flight system having increased frame rate;

FIGS. 4a through 4c pertain to a third improved time-of-flight system having increased frame rate;

FIG. 5 shows a depiction of an image sensor;

FIG. 6 shows a method performed by embodiments described herein;

FIG. 7 shows an embodiment of a camera system;

FIG. 8 shows an embodiment of a computing system.

### DETAILED DESCRIPTION

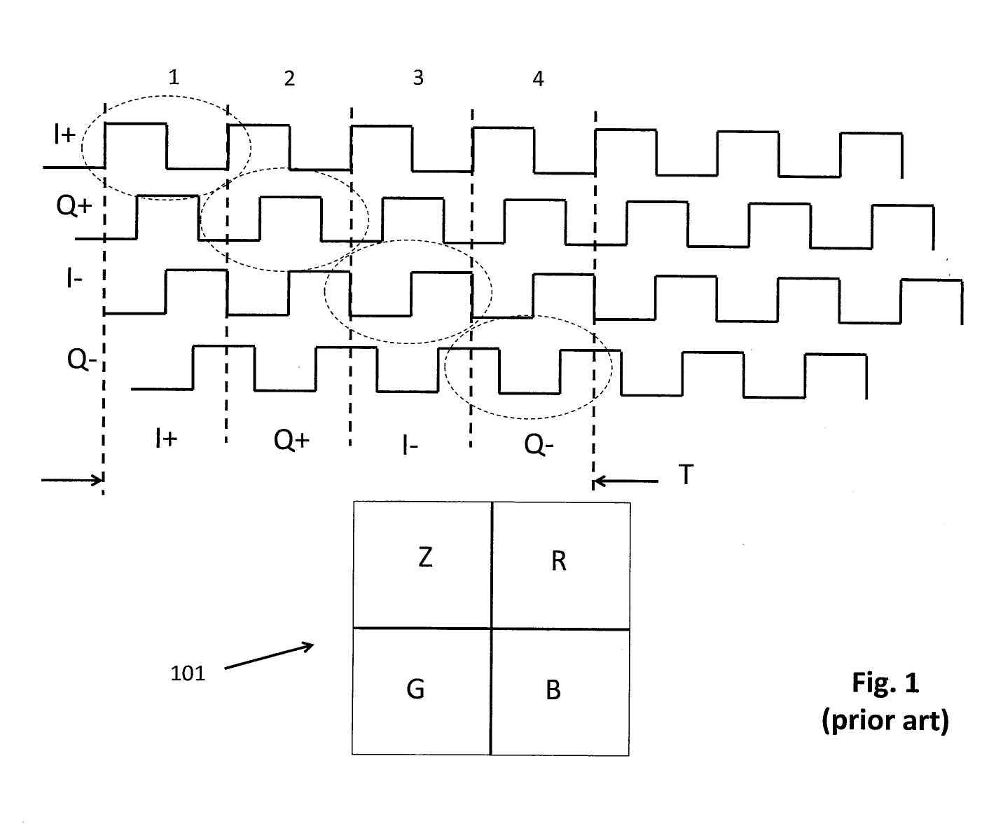

FIG. 1 shows a depiction of the operation of a traditional prior art time of flight system. As observed at inset 101, a portion of an image sensor's pixel array shows a time of flight pixel (Z) amongst a plurality of visible light pixels (red (R), green (G), blue(B)). In a common approach, non visible (e.g., infra-red (IR)) light is emitted from a camera that the image sensor is a part of. The light reflects from the surface of an object in front of the camera and impinges upon the Z pixels of the pixel array. Each Z pixel generates signals in response to the received IR light. These signals are processed to determine the distance between each pixel and its corresponding portion of the object which results in an overall 3D image of the object.

The set of waveforms observed in FIG. 1 correspond to the clock signals that are provided to each Z pixel for purposes of generating the aforementioned signals that are responsive to the incident IR light. Specifically, a set of quadrature clock signals I+, Q+, I−, Q− are applied to a Z pixel in sequence. As is known in the art, the I+ signal typically has 0° phase, the Q+ signal typically has a 90° phase offset, the I− signal typically has a 180° phase offset and the Q− signal typically has a 270° phase offset. The Z pixel collects charge from the incident IR light in accordance with the unique pulse position of each of these signals in succession to generate a series of four response signals (one for each of the four clock signals).

For example, at the end of cycle 1 the Z pixel generates a first signal that is proportional to the charge collected during the existence of the pulse observed in the I+ signal, at the end of cycle 2 the Z pixel generates a second signal that is proportional to the charge collected during the existence of the pulse observed in the Q+ signal, at the end of cycle 3 the Z pixel generates a third signal that is proportional to the charge collected during the existence of pulse observed in the I− signal, and, at the end of cycle 4 the Z pixel generates a fourth signal that is proportional to the charge collected during the existence of the pair of half pulses that are observed in the Q− signal.

The first, second, third and fourth response signals generated by the Z pixel are then processed to determine the distance from the pixel to the object in front of the camera. The process then repeats for a next set of four clock cycles to determine a next distance value. As such, note that four clock cycles are consumed for each distance calculation. The consumption of four clock cycles per distance calculation essentially corresponds to a low frame rate (as frames of distance images can only be generated once every four clock cycles).

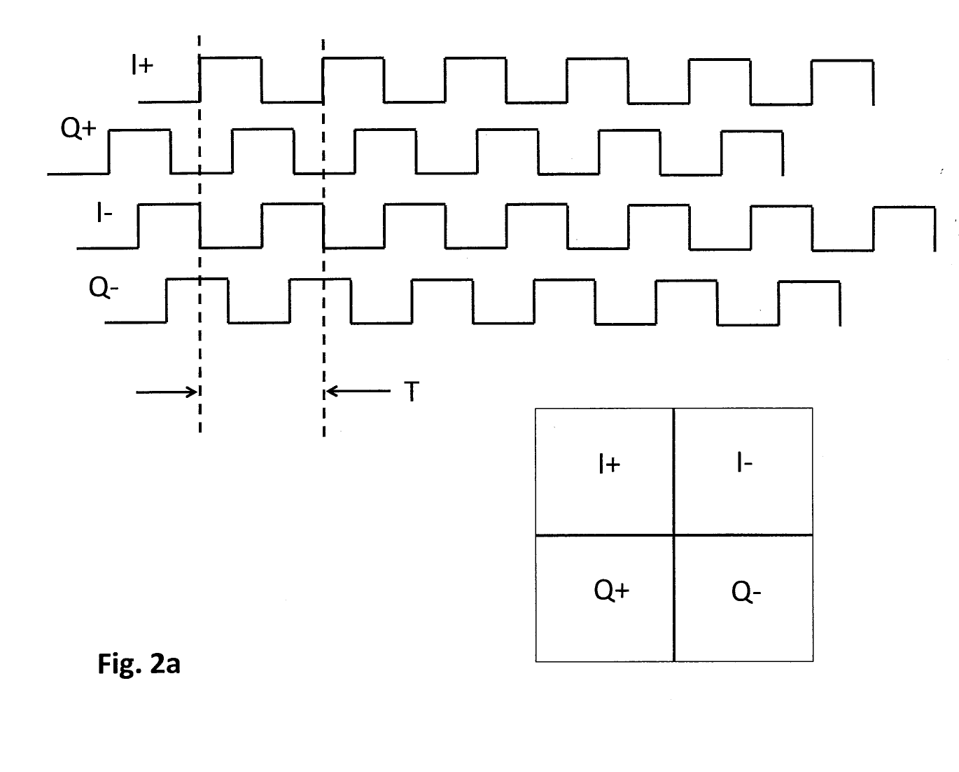

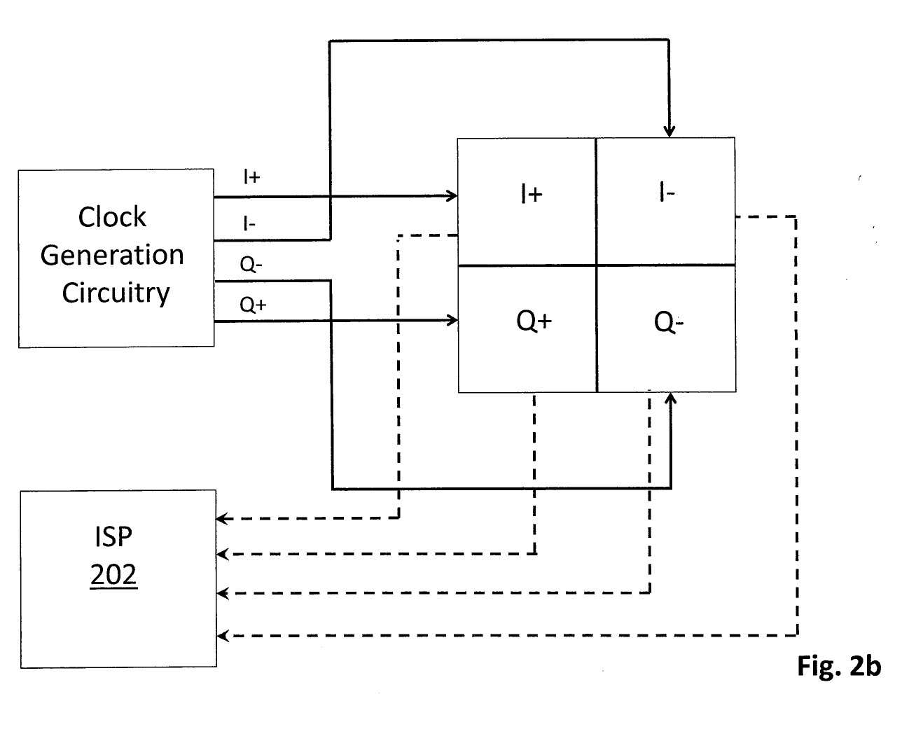

FIG. 2a shows an improved approach in which there are four Z pixels each designed to receive its own arm of the quadrature clock signals. That is, a first Z pixel receives a +I clock, a second Z pixel receives a +Q clock, a third Z pixel receives a −I clock and a fourth Z pixel receives a −Q clock. With each of four Z pixels receiving their own respective quadrature arm clock, the set of four charge response signals needed to calculate a distance measurement can be generated in a single clock cycle. As such, the approach of FIG. 2a represents a 4× improvement in frame rate over the prior art approach of FIG. 1.

FIG. 2b shows an embodiment of a circuit design for an image sensor having a faster depth capture frame rate as described just above. As observed in FIG. 2b, a clock generator generates each of the I+, Q+, I−, Q− signals. One of each of these clock signals is then routed to its own reserved Z pixel. With respect to the output channels from each pixel, note that typically each output channel will include an analog-to-digital-converter (ADC) to convert the analog signals from the pixels into digital values. For illustrative convenience the ADCs are not shown.

An image signal processor 202 or other functional unit (hereinafter ISP) that processes the digitized signals from the pixels to compute a distance from them is shown, however. The mathematical operations performed by the ISP 202 to determine a distance from the four pixel signals is well understood in the art and is not discussed here. However, it is pertinent to note that the ISP 202 can, in various embodiments, receive the digitized signals from the four pixels simultaneously rather than serially. This is distinct from the prior art approach of FIG. 1 where the four signals are received in series rather than in parallel. As such, ISP 202 performs distance calculations every cycle and receives a set of four new pixel values in parallel every cycle.

The ISP 202 (or other functional unit) can be implemented entirely in dedicated hardware having specialized logic circuits specifically designed to perform the distance calculations from the pixel values, or, can be implemented entirely in programmable hardware (e.g., a processor) that executes program code written to perform the distance calculations, or, some other type of circuitry that involves a combination and/or sits between these two architectural extremes.

A possible issue with the approach of FIGS. 2a and 2b is that, when compared with the prior art approach of FIG. 1, temporal resolution has been gained at the expense of spatial resolution. That is, although the approach of FIGS. 2a and 2b have 4× the frame rate of the approach of FIG. 1, the same is achieved by consuming 4× more of the pixel array surface area as compared to the approach of FIG. 1. Said another way, whereas the approach of FIG. 1 only includes one Z pixel to generate the four charge signals that are needed for a distance measurement, by contrast, the approach of FIGS. 2a and 2b requires four pixels to support a single distance measurement. This corresponds to a loss of spatial resolution (less information per pixel array surface area). Although this may be acceptable for various applications it may not be for others.

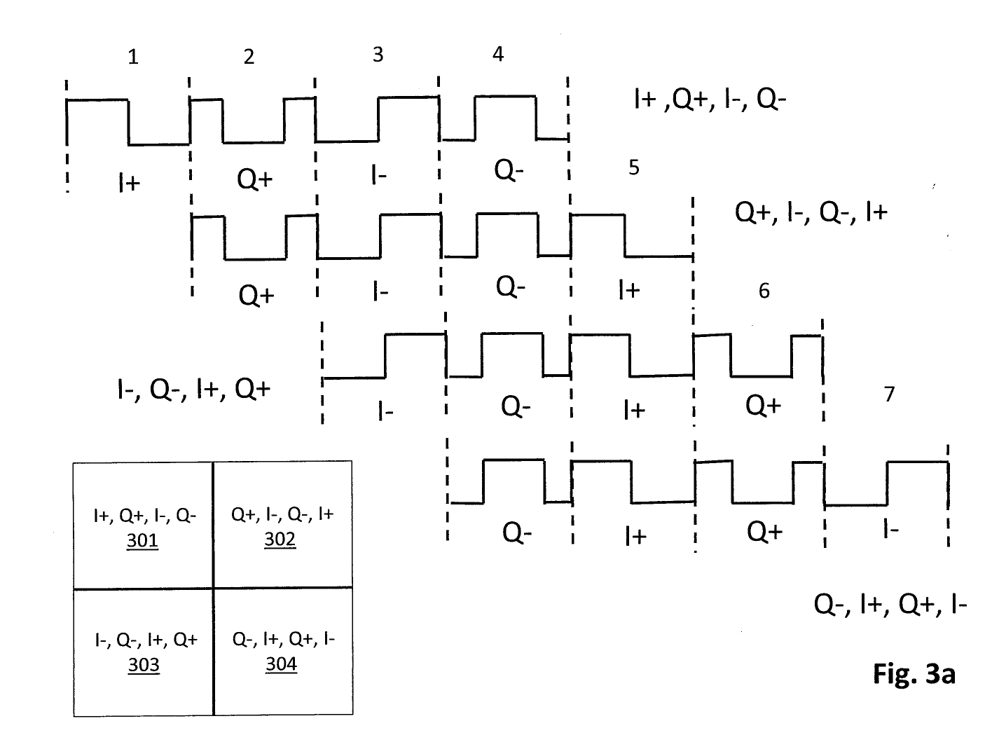

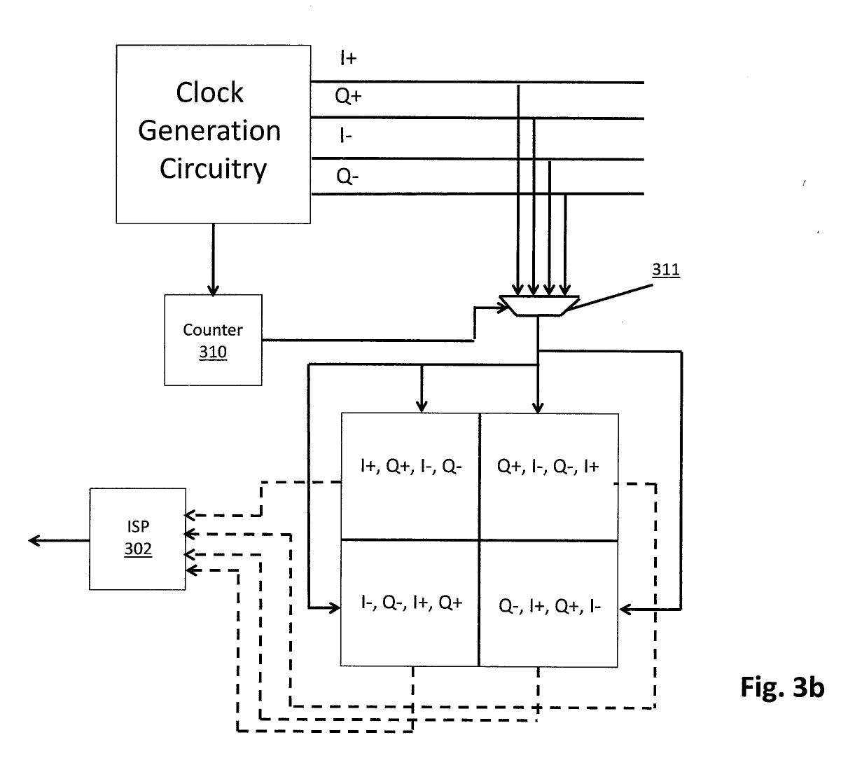

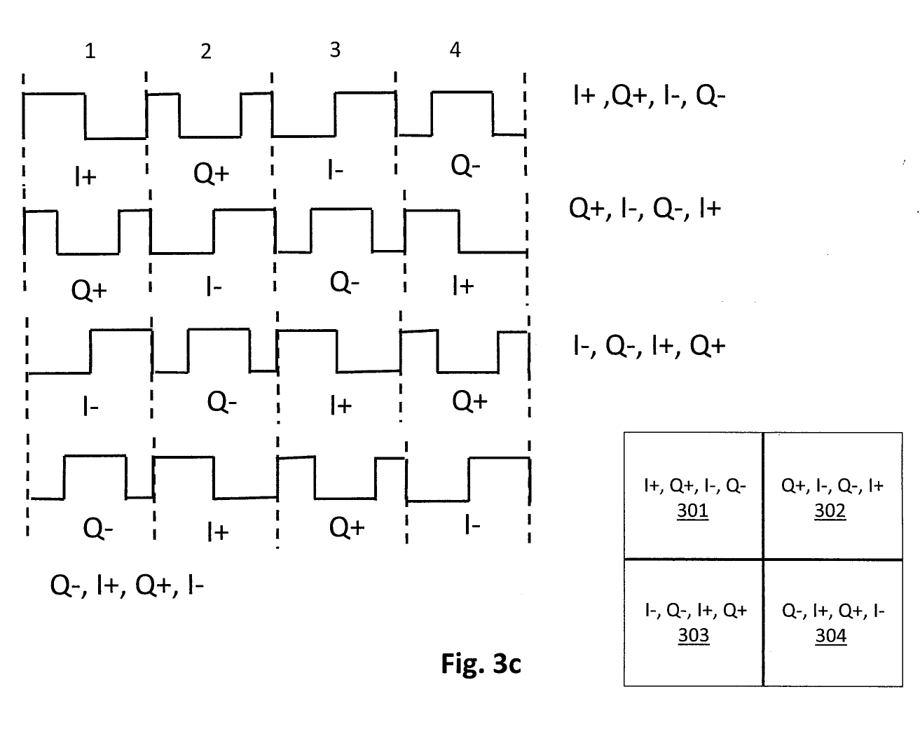

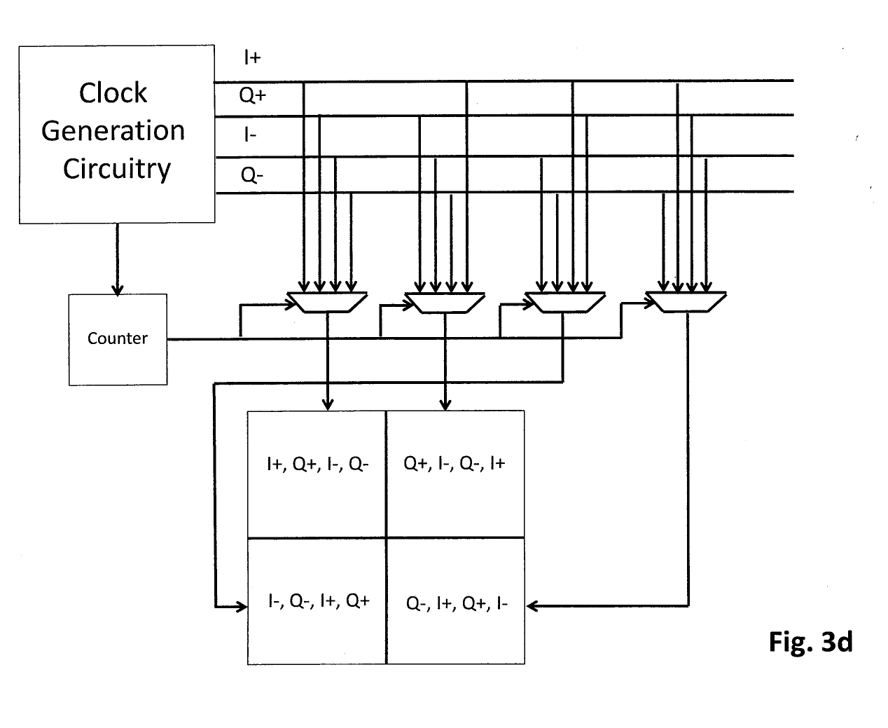

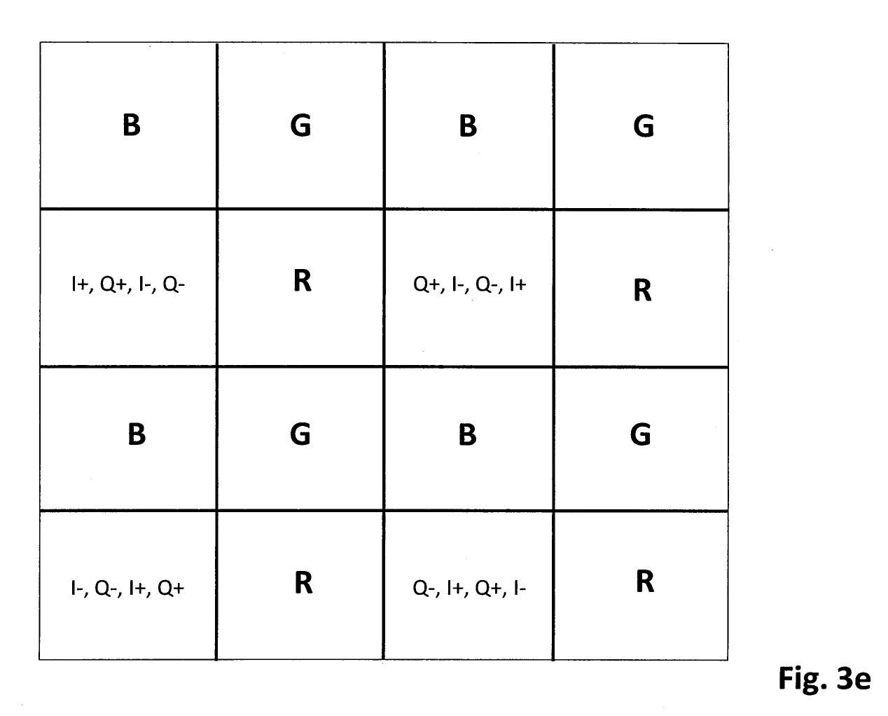

FIGS. 3a, 3b and 3c therefore pertain to another approach that, like the approach of FIGS. 2a and 2b, is able to generate four Z pixel response signals in a single clock cycle. However, unlike the approach of FIGS. 2a and 2b, the spatial resolution for a single distance measurement is reduced to a single Z pixel rather than four Z pixels. As such, the spatial resolution of the prior art approach of FIG. 1 is maintained but the frame rate will have a 4× speed-up like the approach of FIGS. 2a and 2b.

The enhancement of spatial resolution is achieved by multiplexing the different I+, Q+, I− and Q− signals into a single pixel such that on each new clock cycle a different quadrature clock is directed to the pixel. As observed in FIG. 3a each of the four Z pixels may receive the same clock signal on the same clock cycle. However, which of the four clock cycles is deemed to be the last clock cycle after which a distance measurement can be made is different for the four pixels to effectively “rotate” or “pipeline” the pixels output information in a circular fashion.

For example, as seen in FIG. 3a, a first pixel 301 is deemed to receive clock signals in the sequence I+, Q+, I−, Q−, a second pixel 302 is deemed to receive clock signals in the sequence Q+, I−, Q−, I+, a third pixel 303 is deemed to receive clock signals in the sequence I−, Q−, I+, Q+ and a fourth pixel 304 is deemed to receive clock signals in the sequence Q−, I+, Q+, I−. Again, in an embodiment, each of the four pixels 301 through 304 receive the same clock signal on the same clock cycle. Based on the different sequence patterns allocated to the different pixels, however, the different pixels will be deemed to have completed their reception of the four different clock signals on different clock cycles.

Specifically, in the example of FIG. 3a, the first pixel 301 is deemed to have received all four clock signals at the end of cycle 4, the second pixel 302 is deemed to have received all four clock signals at the end of cycle 5, the third pixel 303 is deemed to have received all four clock signals at the end of cycle 6 and the fourth pixel 304 is deemed to have received all four clock signals at the end of cycle 7. The process then repeats. The four pixels 301 through 304 therefore complete their reception of their respective clock signals in a circular, round robin fashion.

With one of the four pixels completing reception of its four clock signals every clock cycle, per pixel distance measurements are achieved with the same 4× speed up in frame rate achieved in the embodiment of FIGS. 2a and 2b (recalling that the embodiment of FIGS. 2a and 2b by design could only measure a single distance with four pixels and not just one pixel). By contrast, unlike the approach of FIGS. 2a and 2b, the spatial resolution is improved to one distance measurement per single Z pixel rather than one distance measurement per four Z pixels.

FIG. 3b shows an embodiment of image sensor circuitry for implementing the approach of FIG. 3a. As observed in FIG. 3b a clock generation circuit generates the four quadrature clock signals. Each of these are in turn provided to different inputs of a multiplexer 311. The multiplexer 311 broadcasts its output to the four pixels. A counter circuit 310 provides a repeating count value (e.g., 1, 2, 3, 4, 1, 2, 3, 4, . . . ) that in turn is provided to the channel select input of the multiplexer 311. As such, the multiplexer 311 essentially alternates selection of the four different clock signals in a steady rotation and broadcasts the same to the four pixels.

An image signal processor 302 or other functional unit that processes the output(s) from the four pixels is then able to generate a new distance measurement every clock cycle. In prior art approaches the pixel response signals are typically streamed out in phase with one another across all Z pixels (all Z pixels complete a set of four charge responses at the same time). By contrast, in the approach of FIG. 3a, different Z pixels complete a set of four charge responses at different times.

As such, the ISP 302 understands the different relative phases of the different pixel streams in order to perform distance calculations at the correct moments in time. Specifically, in various embodiments the ISP 302 is configured to perform distance calculations at different times for different pixel signal streams. As discussed at length above, the ability to perform a distance calculation for a particular pixel stream, e.g., immediately after a distance calculation has just been performed for another pixel stream corresponds to an increase in the frame rate of the overall image sensor (i.e., different pixels contribute to different frames in a frame sequence).

FIGS. 3c and 3d show an alternative approach where the clocks signals are physically rotated. Referring to FIG. 3d, the input channels to the four multiplexers are swizzled as compared to one another which results in physical rotation of each of the four clock signals around the four Z pixels. Although in theory all four Z pixels can be viewed as being ready for a distance measurement at the end of the same cycle, recognizing a unique different pattern for each pixel can still result in having a staged output sequence in which a next Z pixel will be ready for a next distance measurement (i.e., one distance measurement per clock cycle) as in the approach discussed above with respect to FIGS. 3b and 3c.

With respect to either of the approaches of FIGS. 3a,b or 3c,d, because distance measurements can be made at per pixel resolution, the four pixels that share the same clock signals need not be placed adjacent to one another as indicated in FIGS. 3a through 3d. Rather, as observed in FIG. 3e, each of the four pixels may be located some distance away from each other over the pixel array surface area. FIG. 3e shows a pixel array tile that may be repeated across the entire surface area of the pixel array (in an embodiment, each tile receives a single set of four clock signals). As observed in FIG. 3e per pixel distance measurements can be made at four different locations within the tile.

Again, this is in contrast to the approach of FIGS. 2a.b in which a single distance measurement can only be made with four pixels. The four pixels of the approach of FIGS. 2a,b may also be spread out over a tile like the pixels observed in FIG. 3e. However, the distance measurement will be an interpolation across the four pixels over a much wider pixel array surface area rather than a distance measurement from a single pixel.

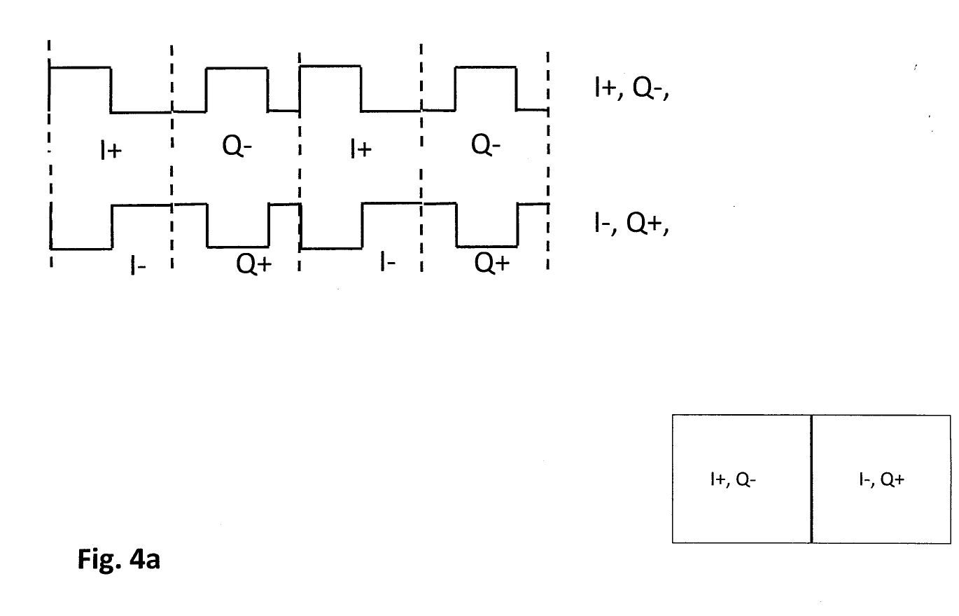

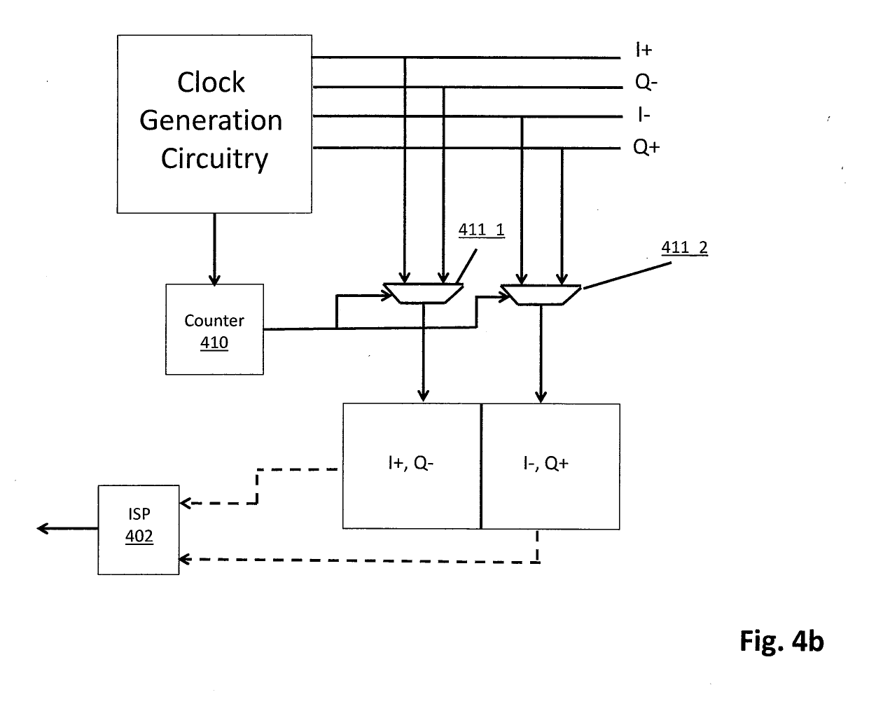

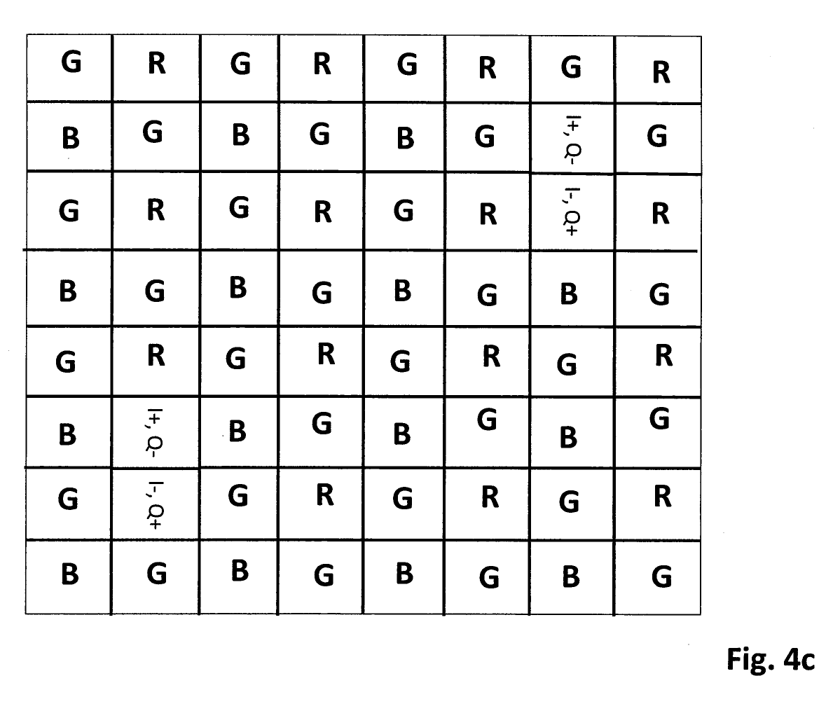

FIGS. 4a through 4c pertain to yet another approach that in terms of spatial resolution architecturally resides somewhere between the approach of FIGS. 2a,b and the approach of FIGS. 3a,-e. Like the approach of FIGS. 2a,b no single pixel receives all four clocks. Therefore, a distance measurement cannot be made from a single pixel (instead distance measurements are spatially interpolated across multiple pixels).

Additionally, like the approach of FIGS. 3a-e, different clock signals are multiplexed to a same pixel which permits the identification of differently phased clock signal patterns and the ability to make distance calculations at a spatial resolution that is better than one distance measurement per four pixels. Unlike either of the approaches of FIGS. 2a,b and 3a-e, however, the approach of FIGS. 4a,b,c executes a distance calculation every other clock cycle rather than every clock cycle. As such the approach of FIGS. 4a,b,c provide for a 2× improvement in frame rate (rather than a 4× improvement as with the approaches of FIGS. 2a,b and 3a-e).

As observed in FIG. 4a, first clock pattern of I+,Q− is multiplexed to a first pixel and a second clock pattern of I−, Q+ is multiplexed to a second pixel. Thus, the two pixel system will have received all four clocks after two clock cycles. As such a distance measurement can be made every two clock cycles.

As observed in FIG. 4b the I+, Q− clock signals are directed to a first multiplexer 411_1 and the I−, Q+ clock signals are directed to a second multiplexer 411_2. A counter 410 repeatedly counts 1, 2, 1, 2 . . . to alternate selection of the pair of input channels of both multiplexers 411_1, 411_2 to effect the multiplexing of the different clock signals to the pair of pixels as described above. First and second charge signals are directed from both pixels on first and second clock cycles. As such, after two clock cycles a set of four charge values are available for use in a distance calculation.

FIG. 4c shows another tile that can be repeated across the surface area of an image sensor's pixel array. Here, note that a pair of Z pixels as described above are placed adjacent to one another to reduce interpolation effects of the particular distance measurement that both their response signals contribute to (other embodiments may spread them out to embrace more interpolation). Two such pairs of pixels are included in the tile to evenly spread out the Z pixels while preserving the order of the RGB Bayer pattern for the visible pixels. The resultant is an 8×8 tile which can be repeated across the surface of the pixel array.

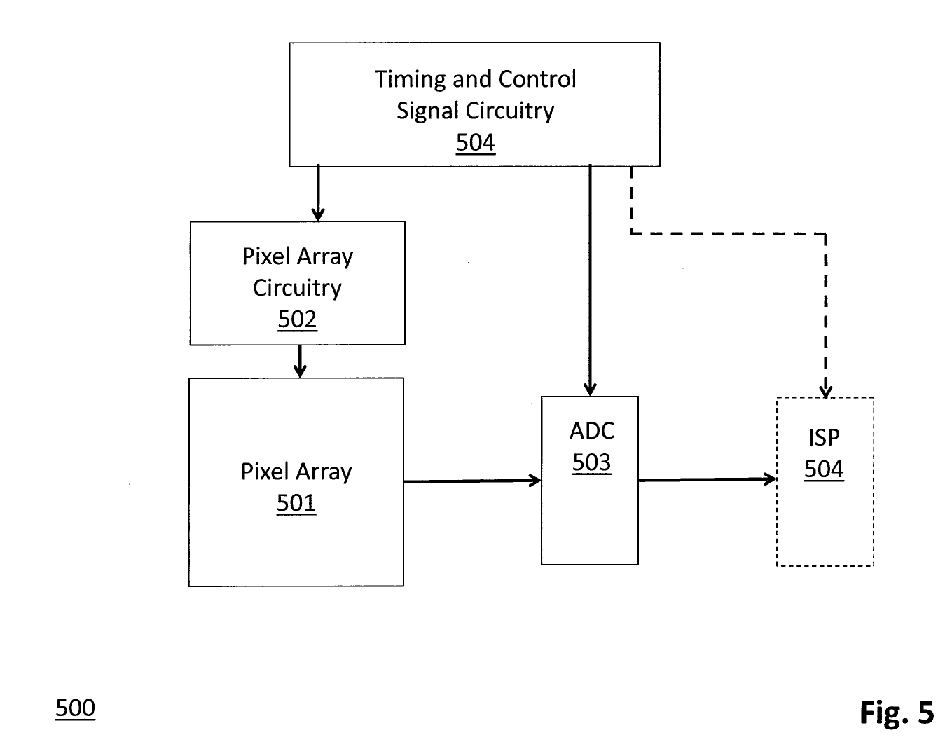

FIG. 5 shows a generic depiction of an image sensor 500. As observed in FIG. 5, an image sensor typically includes a pixel array 501, pixel array circuitry 502, analog to digital (ADC) circuitry 503 and timing and control circuitry 504. With respect to integration of the teachings above into the format of the standard image sensor observed in FIG. 5, it should be clear that any special pixel layout tiles (such as the tiles of FIG. 4c or 5c) would be implemented within the pixel array 501. The pixel array circuitry 502 includes circuitry that is coupled to the pixels of the pixel array (such as row decoders and sense amplifiers). The ADC circuitry 503 converts the analog signals generated by the pixels into digital information.

Timing and control circuitry 504 is responsible for generating the clock signals and resultant control signals that control the overall operation of the image sensor (e.g., controlling the scrolling of row encoder outputs in a rolling shutter mode). The clock generation circuitry, the multiplexers that provide clock signals to the pixels and the counters of FIGS. 2b, 3b and 4b would therefore be implemented as components within the timing and control circuitry 504.

An ISP 504 or other functional unit as described above may be integrated into the image sensor, or, may be part of, e.g., a host side part of a computing system having a camera that includes the image sensor. In embodiments where the ISP 504 is included in the image sensor the timing and control circuitry would include circuitry that causes the ISP to be able to perform, e.g., a distance calculation from different pixel streams that are understood to be providing signals in different phase relationships to effect higher frame rates as described at length above.

It is pertinent to point out that the use of four quadrature clock signals to support distance calculations is only exemplary and other embodiments may use different number of clocks. For example, three clocks may be used if the environment that the camera will be used in can be tightly controlled. Other embodiments may use more than four clocks, e.g., if the extra resolution/performance is needed and the costs are justified. As such those of ordinary skill will recognize that other embodiments may use the teachings provided herein and apply them to time of flight systems that use other than four clocks. Notably this may change the number of pixels that together are used as a cohesive unit to effect higher frame rates (e.g., a block of eight pixels may be used in a system that uses eight clocks.

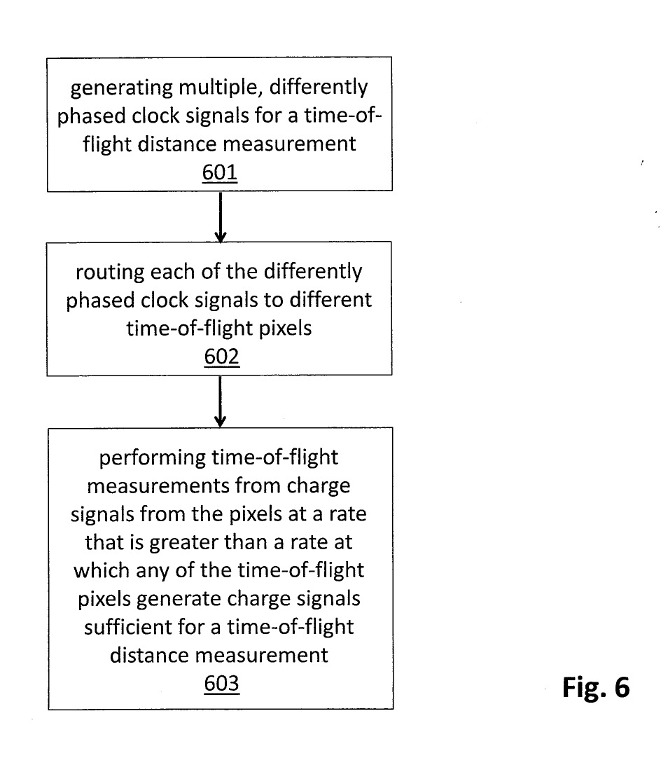

FIG. 6 shows a process performed by an image sensor as described above. As observed in FIG. 6 the process includes generating multiple, differently phased clock signals for a time-of-flight distance measurement 601. The process also includes routing each of the differently phased clock signals to different time-of-flight pixels 602. The method also includes performing time-of-flight measurements from charge signals from the pixels at a rate that is greater than a rate at which any of the time-of-flight pixels generate charge signals sufficient for a time-of-flight distance measurement 603.

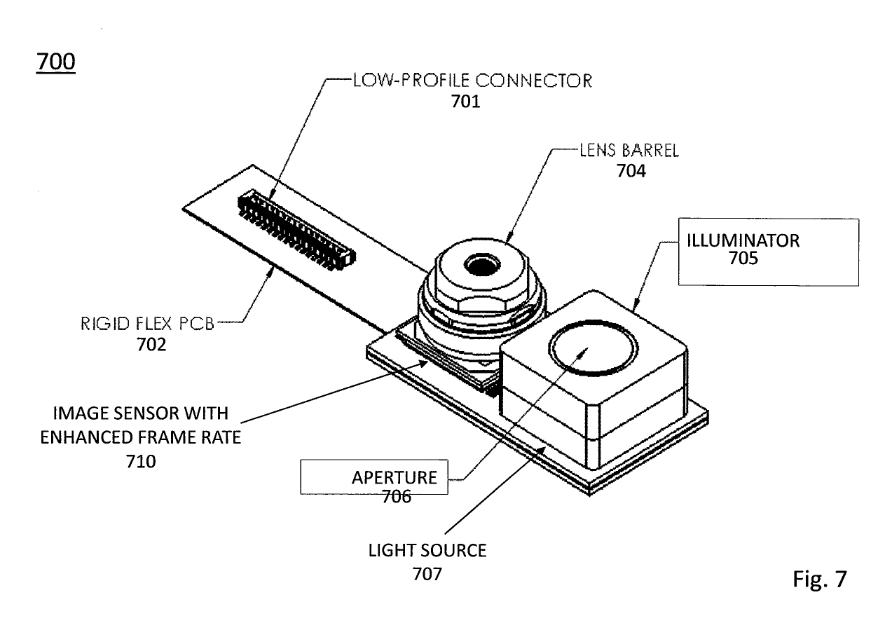

FIG. 7 shows an integrated traditional camera and time-of-flight imaging system 700. The system 700 has a connector 701 for making electrical contact, e.g., with a larger system/mother board, such as the system/mother board of a laptop computer, tablet computer or smartphone. Depending on layout and implementation, the connector 701 may connect to a flex cable that, e.g., makes actual connection to the system/mother board, or, the connector 701 may make contact to the system/mother board directly.

The connector 701 is affixed to a planar board 702 that may be implemented as a multi-layered structure of alternating conductive and insulating layers where the conductive layers are patterned to form electronic traces that support the internal electrical connections of the system 700. Through the connector 701 commands are received from the larger host system such as configuration commands that write/read configuration information to/from configuration registers within the camera system 700.

An RGBZ image sensor 710 and light source driver 703 are mounted to the planar board 702 beneath a receiving lens 702. The RGBZ image sensor 710 includes a pixel array having different kinds of pixels, some of which are sensitive to visible light (specifically, a subset of R pixels that are sensitive to visible red light, a subset of G pixels that are sensitive to visible green light and a subset of B pixels that are sensitive to blue light) and others of which are sensitive to IR light.

The RGB pixels are used to support traditional “2D” visible image capture (traditional picture taking) functions. The IR sensitive pixels are used to support 3D depth profile imaging using time-of-flight techniques. Although a basic embodiment includes RGB pixels for the visible image capture, other embodiments may use different colored pixel schemes (e.g., Cyan, Magenta and Yellow). The image sensor 710 may also include ADC circuitry for digitizing the signals from the pixel array and timing and control circuitry for generating clocking and control signals for the pixel array and the ADC circuitry.

The planar board 702 may likewise include signal traces to carry digital information provided by the ADC circuitry to the connector 701 for processing by a higher end component of the host computing system, such as an image signal processing pipeline (e.g., that is integrated on an applications processor).

A camera lens module 704 is integrated above the integrated RGBZ image sensor and light source driver 703. The camera lens module 704 contains a system of one or more lenses to focus received light through an aperture of the integrated image sensor and light source driver 703. As the camera lens module's reception of visible light may interfere with the reception of IR light by the image sensor's time-of-flight pixels, and, contra-wise, as the camera module's reception of IR light may interfere with the reception of visible light by the image sensor's RGB pixels, either or both of the image sensor's pixel array and lens module 703 may contain a system of filters arranged to substantially block IR light that is to be received by RGB pixels, and, substantially block visible light that is to be received by time-of-flight pixels.

An illuminator 705 composed of a light source array 707 beneath an aperture 706 is also mounted on the planar board 701. The light source array 707 may be implemented on a semiconductor chip that is mounted to the planar board 701. The light source driver that is integrated in the same package 703 with the RGBZ image sensor is coupled to the light source array to cause it to emit light with a particular intensity and modulated waveform.

In an embodiment, the integrated system 700 of FIG. 7 support three modes of operation: 1) 2D mode; 3) 3D mode; and, 3) 2D/3D mode. In the case of 2D mode, the system behaves as a traditional camera. As such, illuminator 705 is disabled and the image sensor is used to receive visible images through its RGB pixels. In the case of 3D mode, the system is capturing time-of-flight depth information of an object in the field of view of the illuminator 705. As such, the illuminator 705 is enabled and emitting IR light (e.g., in an on-off-on-off . . . sequence) onto the object. The IR light is reflected from the object, received through the camera lens module 704 and sensed by the image sensor's time-of-flight pixels. In the case of 2D/3D mode, both the 2D and 3D modes described above are concurrently active.

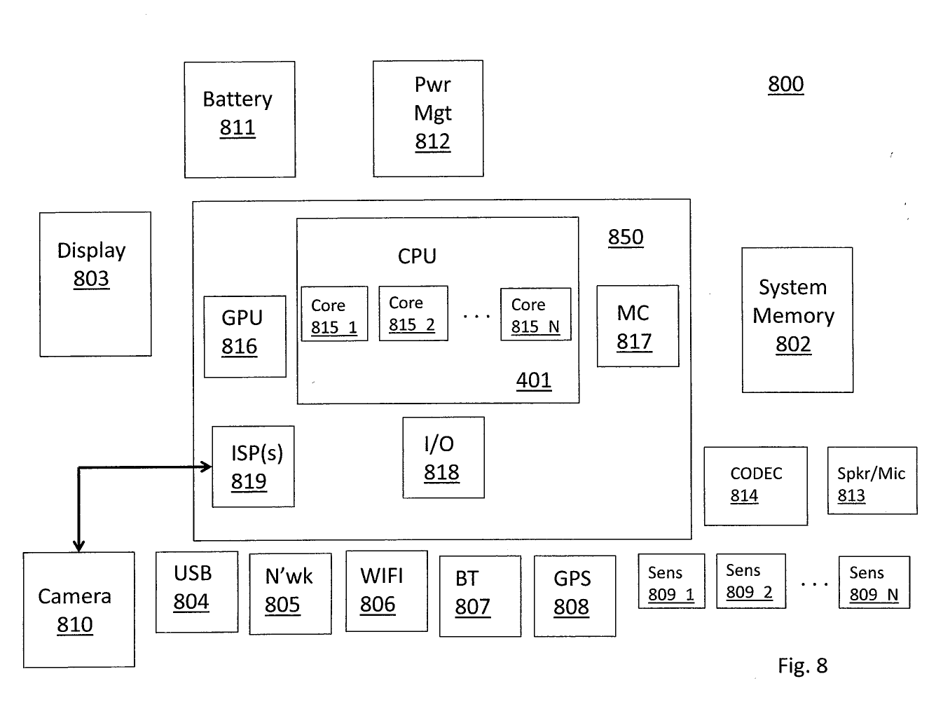

FIG. 8 shows a depiction of an exemplary computing system 800 such as a personal computing system (e.g., desktop or laptop) or a mobile or handheld computing system such as a tablet device or smartphone. As observed in FIG. 8, the basic computing system may include a central processing unit 801 (which may include, e.g., a plurality of general purpose processing cores) and a main memory controller 817 disposed on an applications processor or multi-core processor 850, system memory 802, a display 803 (e.g., touchscreen, flat-panel), a local wired point-to-point link (e.g., USB) interface 804, various network I/O functions 805 (such as an Ethernet interface and/or cellular modem subsystem), a wireless local area network (e.g., WiFi) interface 806, a wireless point-to-point link (e.g., Bluetooth) interface 807 and a Global Positioning System interface 808, various sensors 809_1 through 809_N, one or more cameras 810, a battery 811, a power management control unit 812, a speaker and microphone 813 and an audio coder/decoder 814.

An applications processor or multi-core processor 850 may include one or more general purpose processing cores 815 within its CPU 401, one or more graphical processing units 816, a main memory controller 817, an I/O control function 818 and one or more image signal processor pipelines 819. The general purpose processing cores 815 typically execute the operating system and application software of the computing system. The graphics processing units 816 typically execute graphics intensive functions to, e.g., generate graphics information that is presented on the display 803. The memory control function 817 interfaces with the system memory 802. The image signal processing pipelines 819 receive image information from the camera and process the raw image information for downstream uses. The power management control unit 812 generally controls the power consumption of the system 800.

Each of the touchscreen display 803, the communication interfaces 804-807, the GPS interface 808, the sensors 809, the camera 810, and the speaker/microphone codec 813, 814 all can be viewed as various forms of I/O (input and/or output) relative to the overall computing system including, where appropriate, an integrated peripheral device as well (e.g., the one or more cameras 810). Depending on implementation, various ones of these I/O components may be integrated on the applications processor/multi-core processor 850 or may be located off the die or outside the package of the applications processor/multi-core processor 850.

In an embodiment one or more cameras 810 includes an integrated traditional visible image capture and time-of-flight depth measurement system having an RGBZ image sensor with enhanced frame rate output as described at length above. Application software, operating system software, device driver software and/or firmware executing on a general purpose CPU core (or other functional block having an instruction execution pipeline to execute program code) of an applications processor or other processor may direct commands to and receive image data from the camera system.

In the case of commands, the commands may include entrance into or exit from any of the 2D, 3D or 2D/3D system states discussed above. Additionally, commands may be directed to configuration space of the image sensor and light to implement configuration settings consistent the teachings above. For example the commands may set an enhanced frame rate mode of the image sensor.

Embodiments of the invention may include various processes as set forth above. The processes may be embodied in machine-executable instructions. The instructions can be used to cause a general-purpose or special-purpose processor to perform certain processes. Alternatively, these processes may be performed by specific hardware components that contain hardwired logic for performing the processes, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. (canceled)

2. An image sensor comprising:
a multi-phase clock generator that is configured to generate quadrature clock signals;
a multiplexor that is configured to generate a single clock pattern that includes each of the quadrature clock signals, ordered in a predefined sequence;
first through fourth depth pixels that are each configured to:
receive, during a same clock cycle, a same quadrature clock signal of the single clock pattern that includes each of the quadrature clock signals, ordered in the predefined sequence, and
output a charge signal during a different clock cycle than any other of the depth pixels; and
a processor that is configured to perform a depth calculation after each clock cycle based at least on the output charge signals of one or more of the depth pixels.

3. The sensor of claim 2, wherein the predefined sequences each comprise an I+ clock signal, a Q+ clock signal, an I− clock signal, then a Q− clock signal.

4. The sensor of claim 2, wherein each of the four depth pixels complete on a different clock cycle.

5. The sensor of claim 2, wherein each of the four depth pixels complete after receiving a different one of the quadrature clock signals than any other of the depth pixels.

6. The sensor of claim 2, comprising a counter that outputs a repeating count value to the multiplexor.

7. The sensor of claim 2, wherein the multiplexor selects one of the quadrature clock signals in steady rotation according to the predefined sequence.

8. The sensor of claim 2, wherein each of the four depth pixels is associated with a different set of three or more color pixels.

9. An method comprising:
generating, by a multi-phase clock generator, quadrature clock signals;
generating, by a multiplexor, a single clock pattern that includes each of the quadrature clock signals, ordered in a predefined sequence;
receiving, by each of first through fourth depth pixels and during a same clock cycle, a same quadrature clock signal of the single clock pattern that includes each of the quadrature clock signals, ordered in the predefined sequence;
outputting, by each of the first through fourth depth pixels and during a different clock cycle than any other of the depth pixels, a charge signal; and
performing, by a processor, a depth calculation after each clock cycle based at least on the output charge signals of one or more of the depth pixels.

10. The method of claim 9, wherein the predefined sequences each comprise an I+ clock signal, then a Q+ clock signal, then an I− clock signal, then a Q− clock signal.

11. The method of claim 9, wherein each of the four depth pixels complete on a different clock cycle.

12. The method of claim 9, wherein each of the four depth pixels complete after receiving a different one of the quadrature clock signals than any other of the depth pixels.

13. The method of claim 9, comprising a counter that outputs a repeating count value to the multiplexor.

14. The method of claim 9, wherein the multiplexor selects one of the quadrature clock signals in steady rotation according to the predefined sequence.

15. The method of claim 9, wherein each of the four depth pixels is associated with a different set of three or more color pixels.

16. A system comprising:
a multi-phase clock generator that is configured to generate quadrature clock signals;
a multiplexor that is configured to generate a single clock pattern that includes each of the quadrature clock signals, ordered in a predefined sequence;
first through fourth depth pixels that are each configured to:
receive, during a same clock cycle, a same quadrature clock signal of the single clock pattern that includes each of the quadrature clock signals, ordered in the predefined sequence, and
output a charge signal during a different clock cycle than any other of the depth pixels;
a processor configured to execute computer program instructions; and
a computer storage medium encoded with the computer program instructions that, when executed by the processor, cause the system to perform operations comprising:
performing a depth calculation after each clock cycle based at least on the output charge signals of one or more of the depth pixels.

17. The system of claim 16, wherein the predefined sequences each comprise an I+ clock signal, then a Q+ clock signal, then an I− clock signal, then a Q− clock signal.

18. The system of claim 16, wherein each of the four depth pixels complete on a different clock cycle.

19. The system of claim 16, wherein each of the four depth pixels complete after receiving a different one of the quadrature clock signals than any other of the depth pixels.

20. The system of claim 16, comprising a counter that outputs a repeating count value to the multiplexor.

21. The system of claim 16, wherein the multiplexor selects one of the quadrature clock signals in steady rotation according to the predefined sequence.
